(19) United States
(12) Patent Application Publication
(10) Pub. No.: US 2025/0244190 A1
(43) Pub. Date: Jul. 31, 2025

(54) DETECTION APPARATUS, DETECTION METHOD, AND APPARATUS FOR PROVIDING CENTER-OF-GRAVITY VECTOR FOR DETECTION

(71) Applicant: SEIKO EPSON CORPORATION, TOKYO (JP)

(72) Inventor: Masakazu ISOMURA, SHIOJIRI-SHI (JP)

(21) Appl. No.: 19/040,883

(22) Filed: Jan. 30, 2025

(30) Foreign Application Priority Data
Jan. 30, 2024 (JP) 2024-011517

(51) Int. Cl. G01M 1/16

(52) U.S. Cl. CPC G01M 1/16

(57) ABSTRACT

Center-of-gravity vectors of respective N (1≤N) clusters obtained by dividing into clusters a plurality of state vectors obtained from time-series data reflecting an operation of the inspection target are stored. After the center-of-gravity vector is stored, a detecting state vector is extracted from detection time-series data and a score of the operation state of the inspection target is generated in accordance with a distance of the detecting state vector from the center-of-gravity vector, the detection time-series data being the time-series data obtained anew for the inspection target.

The present application is based on, and claims priority from JP Application Serial Number 2024-011517, filed Jan. 30, 2024, the disclosure of which is hereby incorporated by reference herein in its entirety.

### BACKGROUND

### 1. Technical Field

The present disclosure relates to a detection technique for detecting the operation state of an inspection target, and an apparatus for providing a center-of-gravity vector for detection and providing to outside a center-of-gravity vector required for detection of an operation state, and the like.

### 2. Related Art

Various techniques for detecting the operation state of inspection targets such as various machines and systems have been proposed. For example, JP-A-2021-9441 and JP-A-2023-20770 pre-learn time-series data of an inspection target in a normal state and generate models for predicting time-series data acquired from the inspection target afterward so as to generate failure scores from the difference between the time-series data predicted from the model and the actually acquired time-series data, and detect abnormalities of the inspection target through determination based on the failure scores. As such a model, a machine learning model, a deep learning model or the like is known.

However, these methods compare the time-series data predicted by the model with the time-series data from the inspection target. Therefore, if the prediction accuracy of the model itself is not high enough, the accuracy of the failure score will not be sufficient. To improve prediction accuracy, it is necessary to have a sufficiently large amount of time-series data for training or to increase the number of layers in the neural network used for training. In either case, the time required for training and the hardware configuration will become significant. Moreover, if the time-series data is multichannel (multivariate), the prediction model generally needs to predict all channels, which further increases the computational cost of training and inference.

### SUMMARY

The present disclosure can be implemented by the following embodiments or application examples.

The present disclosure can be implemented as an aspect of a detection apparatus configured to detect an operation state of an inspection target, the detection apparatus. The detection apparatus includes a center-of-gravity vector storage unit storing center-of-gravity vectors of respective N clusters obtained by dividing into clusters a plurality of state vectors obtained from time-series data reflecting an operation of the inspection target, N satisfying 1≤N, and a score generation unit configured to extract a detecting state vector from detection time-series data after the center-of-gravity vector is stored and generate a score of the operation state of the inspection target in accordance with a distance of the detecting state vector from the center-of-gravity vector, the detection time-series data being the time-series data obtained anew for the inspection target.

In addition, the present disclosure can be implemented as a detection method of detecting an operation state of an inspection target. The method includes storing center-of-gravity vectors of respective N clusters obtained by dividing into clusters a plurality of state vectors obtained from time-series data reflecting an operation of the inspection target, N satisfying 1≤N, and extracting a detecting state vector from detection time-series data after the center-of-gravity vector is stored and generating a score of the operation state of the inspection target in accordance with a distance of the detecting state vector from the center-of-gravity vector, the detection time-series data being the time-series data obtained anew for the inspection target.

Further, the present disclosure can be implemented as an apparatus for providing a center-of-gravity vector for detection. The apparatus for providing a center-of-gravity vector for detection includes an accumulation unit configured to accumulate, as a state vector, time-series data reflecting an operation of an inspection target, a dividing unit configured to divide into clusters a plurality of N state vectors accumulated, the N satisfying 1≤N, a center-of-gravity vector storage unit configured to store the center-of-gravity vector determined for each of the clusters divided, and a provision unit configured to provide, for comparison to detect an operation state of the inspection target, the center-of-gravity vector stored, in response to a request from outside.

### BRIEF DESCRIPTION OF THE DRAWINGS

FIG. 1 is a diagram illustrating a schematic configuration of an abnormality detection apparatus according to an embodiment.

FIG. 2 is a diagram illustrating a schematic configuration of a learning mechanism.

FIG. 3 is an explanatory diagram illustrating initialization of a reservoir and learning and inference points.

FIG. 4 is an explanatory diagram illustrating a state of a distribution of state vectors and clustering.

FIG. 5 is a flowchart illustrating an example of a learning process.

FIG. 6 is a flowchart illustrating an example of a clustering process.

FIG. 7 is a flowchart illustrating a process of generating scores and identifying failure scores.

FIG. 8 is an explanatory diagram illustrating a state of identifying failure scores.

FIG. 9 is an explanatory diagram illustrating an example of an average failure score in the embodiment.

FIG. 10 is an explanatory diagram illustrating an example of an increase ratio of an average failure score in the embodiment.

FIG. 11 is an explanatory diagram illustrating an example of a configuration in which only a center-of-gravity vector storage unit is provided on a cloud side.

FIG. 12 is an explanatory diagram illustrating an example of a configuration in which the center-of-gravity vector storage unit and a score generation unit are provided on the cloud side.

### DESCRIPTION OF EMBODIMENTS

### A. Embodiment

### (A1) Hardware Configuration

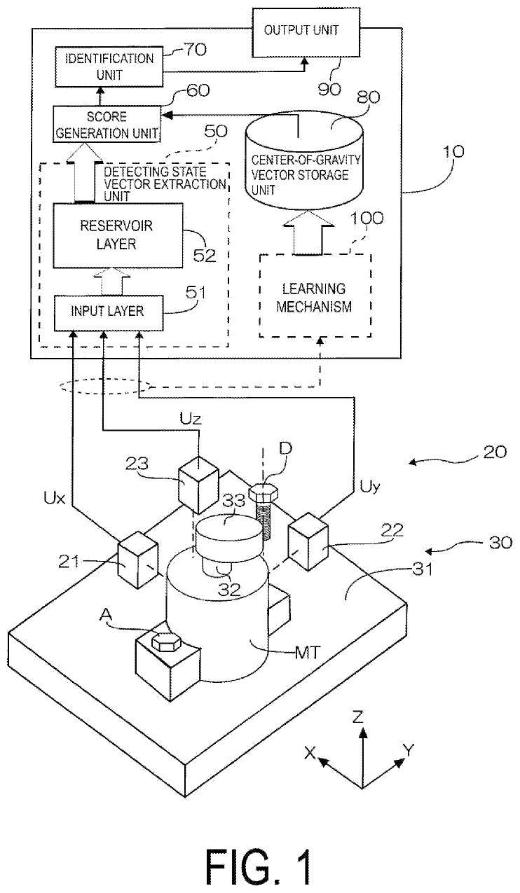

A hardware configuration of a detection apparatus 10 of this embodiment is described below. FIG. 1 is a diagram illustrating a schematic configuration of an abnormality detection system 20 composed of a rotor apparatus 30 and the detection apparatus 10 that detects the abnormality of the rotor apparatus 30. In the drawing, a learning mechanism 100 that performs learning for abnormality detection is illustrated together with the detection apparatus 10. The learning mechanism 100 performs learning of data for abnormality detection before performing the abnormality detection. As described later, in the case where a center-of-gravity vector as a learning result is stored in a center-of-gravity vector storage unit 80, the learning mechanism 100 itself is not required for the detection of the abnormality of the rotor apparatus 30, but is illustrated in FIG. 1 with the broken line for the sake of description. Variations of the configurations of the learning mechanism 100, the center-of-gravity vector storage unit 80 and the like are elaborated later.

As illustrated in the drawing, in the abnormality detection system 20, the detection apparatus 10 detects the abnormality of the rotor apparatus 30. In this example, the detection apparatus 10 is disposed in close proximity to the rotor apparatus 30, and functions as a proximity apparatus that detects the operation state of the rotor apparatus 30. The rotor apparatus 30 includes a motor MT that rotates with power, and fixes it to a base 31 with a first bolt A and a second bolt D. A rotor 33 serving as a power transmission mechanism for driving an object such as a robot arm is attached to a rotation shaft 32 of the motor MT. The rotor 33 is attached eccentrically with respect to the rotation shaft 32 of the motor MT. Accordingly, when the motor MT rotates, the rotor 33 disturbs the balance into an unbalanced state with respect to the rotation shaft of the motor MT. In addition, the attached state of the first bolt A and the second bolt D affects the rotation of the motor MT. When the looseness and rattling of the first bolt A, the second bolt D or the like is out of the normal range, the detection apparatus 10 of this embodiment detects it as abnormality.

The abnormality detection system 20 is provided with X, Y, Z-axis acceleration sensors 21 to 23 that detect the vibration of the rotor 33 in three axis directions and output signals Ux, Uy and Uz. As illustrated in the drawing, the directions of the axes are the Z direction set as the axis direction of the rotation shaft 32 of the motor MT, and the X direction and the Y direction orthogonal to the Z direction. While the acceleration sensors 21 to 23 are separately illustrated in the drawing, it is also possible to use a single sensor that can detect the accelerations in the three axes and output the signals Ux, Uy and Uz of the accelerations corresponding to the vibrations of the axes.

The detection apparatus 10 includes a detecting state vector extraction unit 50 that extracts a detecting state vector that is a state vector for abnormality detection with the input of the signals Ux, Uy and Uz output by the acceleration sensors 21 to 23, a score generation unit 60 that generates a score of the operation state of the rotor apparatus 30 as an inspection target, an identification unit 70 that identifies the failure score of the rotor apparatus 30 from the generated score, the center-of-gravity vector storage unit 80 that stores a center-of-gravity vector that is referred to in the score generation, and an output unit 90 that outputs an index corresponding to the possibility of failure in accordance with the value of the failure score. The detection apparatus 10 of this embodiment is provided with an arithmetic logic unit composed of known CPUs, GPUs, memory and the like, and at least a part of the detecting state vector extraction unit 50, the score generation unit 60 and the like described above is implemented when programs stored in the memory are sequentially executed by the CPU and the like. Note that the same applies to the learning mechanism 100. Naturally, the detecting state vector extraction unit 50 and the like may be implemented by dedicated hardware.

The detecting state vector extraction unit 50 includes inside an input layer 51 and a reservoir layer 52. The detecting state vector extraction unit 50 is configured as a reservoir computing without an output layer, and the input layer 51 inputs the signals Ux, Uy and Uz of the triaxial acceleration sensors 21 to 23. The reservoir layer 52 includes an echo state network that is a recurrently coupled, multi-layered neuronal. The reservoir layer 52 outputs a detecting state vector that indicates the state of the rotor apparatus 30.

The extracted detecting state vector is output to the score generation unit 60. The score generation unit 60 determines the score representing the state of the rotor apparatus 30 on the basis of the detecting state vector and the center-of-gravity vector stored in the center-of-gravity vector storage unit 80, and outputs the score. The identification unit 70 that has received the score identifies the failure score of the rotor apparatus 30, and when the failure score is greater than a predetermined value, outputs it to the outside through the output unit 90. The generation of the score in the score generation unit 60 requires the center-of-gravity vector determined in advance by the learning mechanism 100 and stored in the center-of-gravity vector storage unit 80. In view of this, the configuration and operation of the learning mechanism 100 are described before describing the configuration of the detecting state vector extraction unit 50. Note that the configuration of the learning mechanism 100 and the configuration of the detecting state vector extraction unit 50 are common in that they both use the reservoir computing function. In view of this, the description of the learning mechanism 100 also contributes to an understanding of the detecting state vector extraction unit 50.

### (A2) Configuration and Operation of Learning Mechanism 100

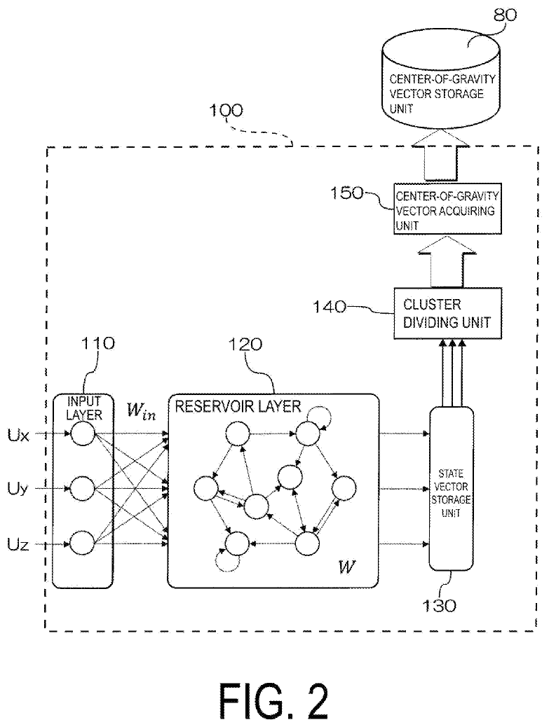

As described above, the learning mechanism 100 illustrated in FIG. 1 is not necessarily required for detecting the abnormality of the operation of the rotor apparatus 30, but it is necessary that learning of the center-of-gravity vector and the like have been performed before the detection apparatus 10 detects the abnormality of the rotor apparatus 30. In view of this, the configuration and operation of the learning mechanism 100 are described with reference to FIG. 2. The learning mechanism 100 is configured as a reservoir computing without an output layer, and includes an input layer 110 that inputs the signals Ux, Uy and Uz of the triaxial acceleration sensors 21 to 23, a reservoir layer 120 that includes an echo state network that is a recurrently coupled, multi-layered neuronal, a state vector storage unit 130 that stores the output of the reservoir layer 120 as a state vector, a cluster dividing unit 140 that divides a plurality of stored state vectors into a plurality of clusters, and a center-of-gravity vector acquiring unit 150 that computes the center-of-gravity vector of each divided cluster. The center-of-gravity vector of each cluster determined by the center-of-gravity vector acquiring unit 150 is stored in the center-of-gravity vector storage unit 80.

In this embodiment, a coupling weight matrix Win of the input layer 110 and the reservoir layer 120 is set to the uniformly distributed random number of the section [−1, 1] (random seed: 4, scale factor: approximately 1.21). In addition, the coupling weight matrix W in the reservoir layer 120 is set as the uniformly distributed random number of the section [−1, 1] (random seed: 4, coupling density: approximately 0.4, ESP requirement: approximately 0.99/ρ). Note that ρ is the spectral radius of the matrix.

When x(t) represents the state vector of the reservoir layer 120 at time t and u(t) represents the input data, the unsupervised learning model illustrated in the drawing (input layer+reservoir layer) is represented by the following Equation (1). Here, x(t−1) represents the state vector at one previous sampling time point.

$$x ( t ) = f ( Win \cdot u ( t ) + W \cdot x ( t - 1 ) ) \qquad ( 1 )$$

In Equation (1), f represents the activation function, here tan h.

The input u(t) in this embodiment is the above-described triaxial acceleration data Ux(t), Uy(t) and Uz(t). Accordingly, the number of dimensions of the input is 3. In the following description, when these pieces of acceleration data are handled as a vector, they are represented by u(t). In addition, the dimension of the state vector is 64.

In this embodiment, in order to make the update of the reservoir layer 120 moderate, the state vector x(t) is determined by the following Equation (2) using a leak rate α.

$$x ( t ) = ( 1 - α ) \cdot x ( t - 1 ) + α \cdot f ( Win \cdot u ( t ) + W \cdot x ( t - 1 ) ) \qquad ( 2 )$$

Here the leak rate α is a minute value of about 0.0005 to 0.001.

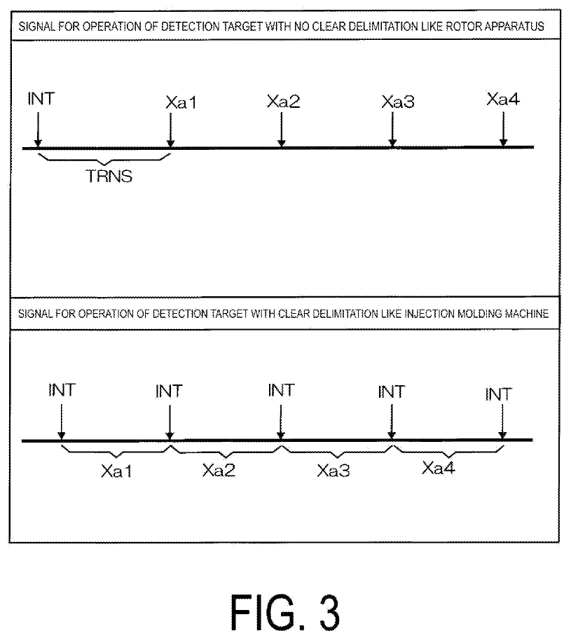

FIG. 3 illustrates an example of the input data u(t) to be input to the unsupervised learning model composed of the input layer 110 and the reservoir layer 120. In the drawing the upper section illustrates an example of a case where continuous rotation vibration such as the rotor apparatus 30 or the like is the input data, and the lower section illustrates an example of a case of using data based on a delimited operation such as an operation from the start to completion of a molding operation of a product in an injection molding machine or the like, for example. In the case of the rotor apparatus 30, the triaxial acceleration signal as the input data has no clear delimitation. In view of this, initialization INT of the reservoir layer 120 is performed only once at the beginning, and thereafter, learning of the state vector x(t) is performed at regular intervals based on the input data u(t). Note that as illustrated in the drawing, the timing of the first learning after initialization is delayed by a predetermined time TRNS than usual to avoid the influence of learning transient responses of the reservoir layer 120.

The rotational frequency of the rotor apparatus 30 subjected to learning was set to 1200 rpm, and the sampling frequency of the triaxial acceleration sensors 21 to 23 for detecting its vibration, or acceleration, was set to 1 KHz. The input layer 110 down-samples to ½, i.e., 0.5 KHz, the signals Ux, Uy and Uz from the acceleration sensors 21 to 23, and performs the learning of the state vector at an interval of 0.5 seconds at timings Xa1, Xa2 . . . as illustrated in the drawing.

In the case where there is a clear delimitation for each shot in the operation of the learning target such as an injection molding machine, it suffices to perform the initialization INT of the state vector for each cycle of the operation as illustrated in the lower section in the drawing, and then perform learning by determining averages Xa1, Xa2, . . . of the state vectors therebetween.

In the learning of the vibration state of the rotor apparatus 30, the length of a single file for the learning is set to about 105 seconds, and data of 90 seconds from 10 to 100 seconds is set by excluding 10 seconds from the start of the file in consideration of the matching of the transient response period of the acceleration sensor and the data length.

The state vector x(t) obtained in the above-described manner is stored in the state vector storage unit 130, and a large number of stored state vectors x(t) is divided into a plurality of clusters by the cluster dividing unit 140. The cluster division may be performed after the large number of state vectors x(t) is stored, or may be sequentially performed each time the state vector x(t) is obtained as described later.

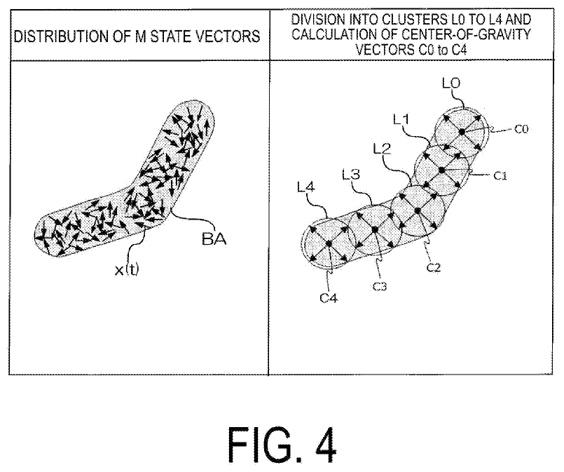

While the clustering process performed by the cluster dividing unit 140 is elaborated later, the clustering groups state vectors that are close in distance. This state is schematically illustrated in FIG. 4. The state vector x(t) obtained in this embodiment is a multidimensional vector, but for the sake of description, this is illustrated as M two-dimensional vectors. For a set BA of the M state vectors x(t), the cluster dividing unit 140 groups the state vectors x(t) that are close in distance among the state vectors x(t) in the region BA. In the example illustrated in the drawing, the M state vectors x(t) are divided into five clusters L0 to L4. In this case, the center-of-gravity vector acquiring unit 150 determines the center-of-gravity vectors C0 to C5 for each of the clusters L0 to L4. The determined center-of-gravity vector is stored in the center-of-gravity vector storage unit 80.

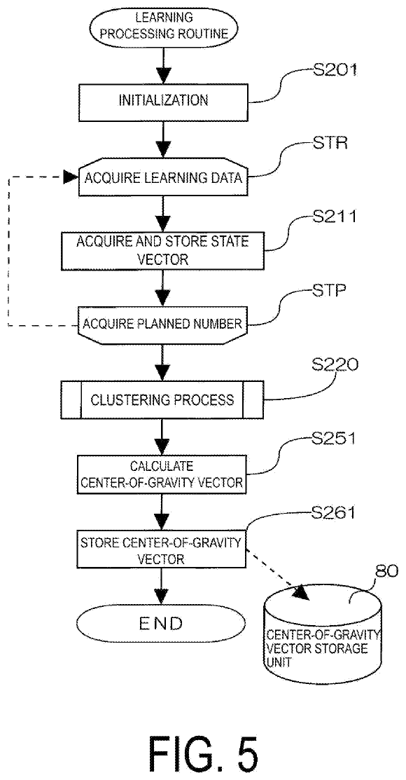

FIG. 5 is a flowchart illustrating an example of a process performed by the learning mechanism 100. When this process is started, the learning mechanism 100 performs an initialization process first (step S201). In the initialization process, the state vectors and the like in the reservoir layer 120 and the input layer 110 are initialized, and the process of waiting for the elapse of the transient response period of the rotor apparatus 30 subjected to learning is performed as described with reference to FIG. 3. Subsequently, a process of acquiring and storing the state vector of the learning target (step S211) is repeated the planned number of times (from steps STR to STP). When the rotor apparatus 30 is operated and its triaxial accelerations Nx, Ny, Nz are sampled at a predetermined sampling rate, the process is performed at the reservoir layer 120 with the sampled time-series data, and the obtained result is acquired as the state vector x(t).

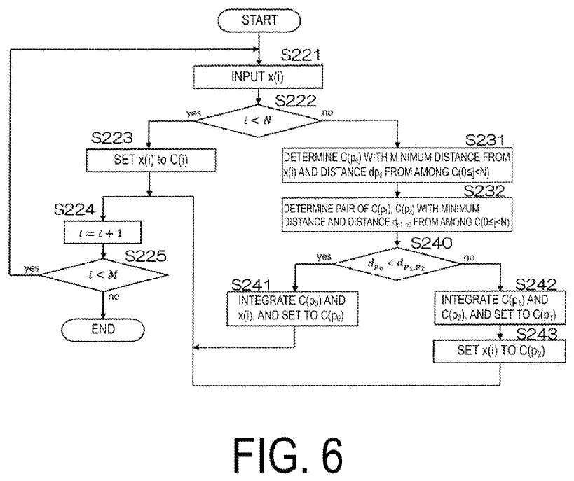

When the predetermined number of state vectors x(t) is acquired, the clustering process is performed (step S220). Here, a sequential clustering method (SCM) is performed. FIG. 6 illustrates an example of this process. In FIG. 5, the clustering process (step S220) is performed after the M state vectors x(t) are acquired for the sake of the correspondence with the block diagram of the learning mechanism 100, but it can be executed each time the state vector x(t) is acquired anew because the SCM is sequential clustering. Once the M state vectors x(t) is stored in the state vector storage unit 130, clustering methods other than the SCM, such as K-means++ or hierarchical clustering, may be employed.

While clustering processes using SCM are known and detailed description thereof is omitted, the process illustrated in FIG. 6 is started after initializing a variable i that identifies the order of the state vector to be processed after the initialization process (step S201). Here, x(i) represents the ith state vector, and C(j) represents the jth center-of-gravity vector. Note that 0≤i<M, 0≤j<N holds. When a processable state vector x(i) is input (step S221), the first N (0≤i<N) state vectors x(i) are directly set to the center-of-gravity vector C(i) of the cluster (step S222, 223). N represents the number of clusters. Thereafter, the variable i is incremented (step S224), and the process is repeated again from step S221 until the process for the M state vectors x(i) is completed (step S225: “yes”).

From the N+1st state vector x(i) (step S222, “no”), the center-of-gravity vector C(p0) with the minimum distance and the distance dp0 thereof are determined from among the already determined ones. Subsequently, the pair of C(p1) and C(p2) with the minimum distance and the distance dp1−p2 thereof are determined from among the center-of-gravity vectors C(step S222, S231, S232).

After the above-described processes, the relationship between the distance dp0 and the distance dp1−p2 is determined. When dp0<dp1−p2 holds, the center-of-gravity vector C(p0) and the input state vector x(i) are integrated, and its value is set to the center-of-gravity vector C(p0) (step S240, S241). On the other hand, when dp0<dp1−p2 does not hold, the center-of-gravity vector C(p1) and the center-of-gravity vector C(p2) are integrated, and its value is set to the center-of-gravity vector C(p1), and the state vector x(i) is set to the center-of-gravity vector C(p2) (steps S240, S242 and 243). Note that for the center-of-gravity vector, the integration of the vectors is performed through weighted average considering the number of state vectors integrated. After the above-described processes, again, whether the increment of the variable i and the clustering for M state vectors has been completed is determined (steps S224 and 225), and the clustering process is terminated upon completion of clustering of M state vectors (step S225: “no”).

Through the above-described clustering process, j clusters are formed from the M state vectors, and the center-of-gravity vectors C(0) to C(j−1) of the clusters are determined as exemplified in FIG. 4. With reference to FIG. 5, in the sequential clustering process, the calculation of the center-of-gravity vector (step S251) and the storage of the center-of-gravity vector (step S252) are also executed, and the center-of-gravity vector is stored in the center-of-gravity vector storage unit 80. In the case where the clustering is not a sequential process, the clustering and the calculation and storage of the center-of-gravity vector may be separately performed as illustrated in FIG. 5. The learning mechanism 100 described above with reference to FIG. 2 and the like may be configured as the apparatus for providing a center-of-gravity vector for detection separately from the detection apparatus 10, and may be independently implemented.

### (A3) Abnormality Detection of Inspection Target

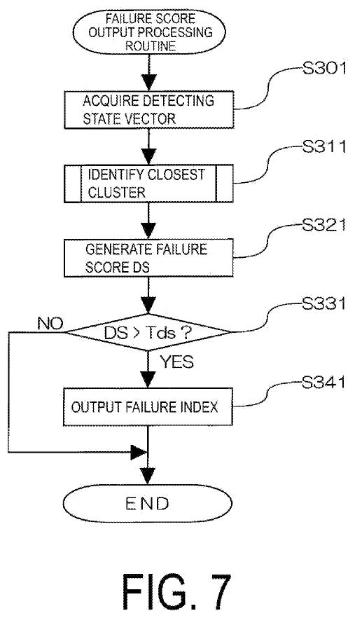

The following describes the above-described configuration, i.e., an abnormality detection process that is performed in the state where the learning mechanism 100 has performed the learning of the state of the rotor apparatus 30 to be inspected and then the center-of-gravity vector C(j) of each cluster has been stored with the M state vectors x(t) clustered in the center-of-gravity vector storage unit 80. As illustrated in FIG. 1, the detecting state vector extraction unit 50 of the detection apparatus 10 is provided with the input layer 51 and the reservoir layer 52 with the same configurations as those of the input layer 110 and the reservoir layer 120 of the learning mechanism 100 described above. Thus, when the same acceleration signal is input from the triaxial acceleration sensors 21 to 23, the detecting state vector extraction unit 50 outputs the state vector x(t) as with the learning mechanism 100. On the basis of such a configuration, the detection apparatus 10 generates the score of the operation state of the rotor apparatus 30 as the detection target, and detects it when there is an abnormality in the rotor apparatus 30. FIG. 7 is a flowchart illustrating a failure score processing routine that is an example of abnormality detection processing executed by the detection apparatus 10.

When the detection apparatus 10 starts the failure score processing routine in the state where the learning is completed, the state vector x(t) for detecting the operation state of the rotor apparatus 30 is acquired (step S301) on the basis of the signals from the triaxial acceleration sensors 21 to 23 that are detection time-series data along with the operation of the rotor apparatus 30. The signal from the triaxial acceleration sensors 21 to 23 is the same as the signal that is input to the learning mechanism 100 in learning, but this signal is referred to as “detection time-series data” for the sake of distinction because it is not for learning the state vector, but for detecting the operation state of the inspection target. Likewise, the state vector extracted by the detecting state vector extraction unit 50 is the same in configuration as the state vector that is acquired by the learning mechanism 100 in learning, but is referred to as “detecting state vector” for the sake of distinction in description. When a detecting state vector is acquired from the rotor apparatus 30 that is being operated, then a process of identifying a cluster L(j) located closest to that detecting state vector on the basis of the center-of-gravity vector and the state vector cluster stored in the center-of-gravity vector storage unit 80 is performed (step S311). The closest cluster can be selected by determining the distance from the center of gravity of each cluster.

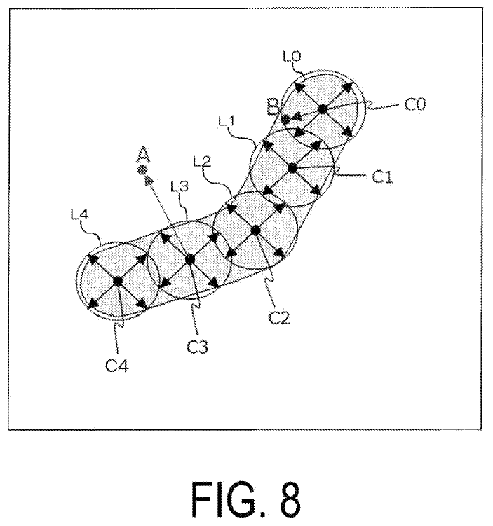

For example, as illustrated in FIG. 8, when the acquired state vector x(t) is represented by a point A, distances from each of clusters L(0) to L(4) of center-of-gravity vectors C(0) to C(4) (scores) are determined. From among such scores, the distance from the center-of-gravity vector C(3) of the closest cluster L(3) is determined as a failure score DS (step S321).

Subsequently, whether the failure score DS is greater than a predetermined threshold value Tds is determined (step S331), and when the failure score DS is greater than the threshold value Tds, a process of outputting the failure score DS as an index indicating the degree of failure is performed (step S341). When the failure score DS is smaller than the threshold value Tds, no process is performed. As illustrated in FIG. 8, the threshold value Tds is a value larger than the average distance from the center-of-gravity vector C(j) of each cluster L(j) by a predetermined value. In this manner, in the example illustrated in the drawing, when the average of a predetermined number of the detected state vectors x(i) is a vector that reaches the point A, the failure score DS corresponding to the distance from the center-of-gravity vector C(3) of the closest cluster L(3) is larger than the threshold value Tds. Conversely, when the average of a predetermined number of the detected state vectors x(i) is a vector that reaches a point B, the failure score DS corresponding to the distance from the center-of-gravity vector C(0) of the closest cluster L(0) is smaller than the threshold value Tds. Accordingly, in this example, when the average of a predetermined number of the detected state vectors x(i) is a vector that reaches the point A, it is determined that there is an abnormality, and the output unit 90 makes a certain abnormality notification. This abnormality notification is the output of a failure index in this embodiment. The output of the failure index may be made using any indexes and methods such as abnormality notification with sound, indication using printers or screens, and classification (normal/abnormal) of detection target.

Through the above-described processes, the abnormality detection system 20 can easily detect the abnormality in the rotor apparatus 30 by using the score determined based on the state vector. Moreover, when learning the signal from the triaxial acceleration sensors 21 to 23 at the rotor apparatus 30 with the learning mechanism 100 including the input layer 110 and the reservoir layer 120, it is not necessary to perform the task of iteratively learning weights in a multi-layer neural network. Since this embodiment employs the technique of reservoir computing, it suffices to preliminarily set as random values the coupling weight matrix Win of the input layer 110 and the reservoir layer 120 and the coupling weight matrix W in the reservoir layer 120, and it is not necessary to perform the learning of the weight by techniques such as backpropagation. In addition, since the state vector in the reservoir layer 120 is used, it is not necessary to perform the learning of the coupling weight matrix to the output layer.

To verify the operation of the abnormality detection system 20 of this embodiment, differences in the score DS under the following conditions were determined. In the rotor apparatus 30, the rotor 33 is eccentrically provided with respect to the rotation shaft 32, and therefore when the motor MT rotates, vibration occurs in the entire rotor apparatus 30, and the acceleration sensors 21 to 23 detect the vibration of the apparatus. It is necessary for the abnormality detection system 20 to determine whether the vibration is normal, or includes some abnormality. The abnormality in the rotor apparatus 30 illustrated in FIG. 1 is considered to occur when the balance in the normal rotor apparatus 30 is disturbed such as with looseness of the first bolt A and the second bolt D. Such disturbed balance was intentionally caused as the following six types of imbalances.

### Types (Reference Symbols): Imbalances

<1> AnDn: rotor 33+first bolt A+second bolt D
<2> AnDw: rotor 33+first bolt A+second bolt Dw
<3> AwDn: rotor 33+first bolt Aw+second bolt D
<4> AwDw: rotor 33+first bolt Aw+second bolt Dw
<5> AnDv: rotor 33+first bolt A+second bolt Dv
<6> AvDn: rotor 33+first bolt Av+second bolt D

Note that the symbol w represents that a thin washer is attached to the bolt, the symbol v represents that a thick washer is attached to the bolt, and the symbol n represents that no washer is attached to the bolt.

<1> to <4> were obtained from data of 32 files, and <5> and <6> were obtained from data of 16 files. As described above each file was obtained by sampling 90-second vibration at predetermined intervals.

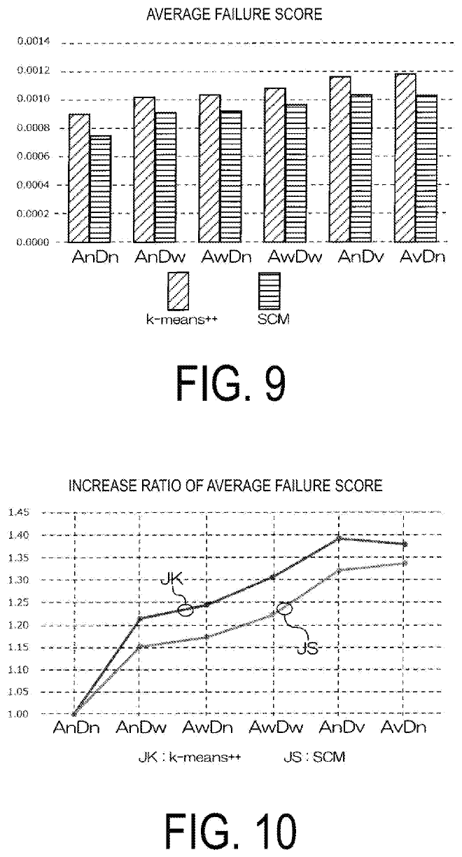

FIG. 9 is a graph illustrating an example of average failure scores of <1> to <6> described above. In the graph, the oblique hatching is a graph of a case where clustering is performed by k-means++, and the lateral hatching is a graph of a case where clustering is performed by SCM, which is sequential clustering. As illustrated in the graph, the sequential clustering resulted in relatively lower average scores, but in either clustering, the failure score was significantly higher when the bolts are not normally attached (<2> to <6>: with washer) than when the first bolt A and/or the second bolt D is normally attached (<1> AnDn: no washer).

FIG. 10 clearly illustrates these results by the increase rate of failure scores. In FIG. 10, the line JK indicates the increase rate of the failure score of a case where clustering is performed by k-means++, the line JS indicates the increase rate of a case where clustering is performed by SCM, which is sequential clustering. It is shown that the failure score increased 1.2 to 1.4 times when the bolts are not normally attached (<2> to <6>: with washer) with respect to the case where the first bolt A and/or the second bolt D is normally attached (<1>AnDn: no washer). In this manner, attaching abnormality of the rotor apparatus 30 can be easily detected by appropriately selecting the threshold value Tds.

### B. Other Embodiments

(1) The present disclosure can be implemented in an aspect of a detection apparatus configured to detect an operation state of an inspection target as described below. The detection apparatus includes a center-of-gravity vector storage unit storing center-of-gravity vectors of respective N clusters obtained by dividing into clusters a plurality of state vectors obtained from time-series data reflecting an operation of the inspection target, N satisfying 1≤N, and a score generation unit configured to extract a detecting state vector from detection time-series data after the center-of-gravity vector is stored and generate a score of the operation state of the inspection target in accordance with a distance of the detecting state vector from the center-of-gravity vector, the detection time-series data being the time-series data obtained anew for the inspection target.

In this manner, by extracting the detecting state vector from the detection time-series data obtained anew for the inspection target, it is possible to generate the score of the operation state of the inspection target generated in accordance with the distance of the detecting state vector from the center-of-gravity vector. Regarding the inspection target, in the case of a target in which the start and end of a series of operation is clear such as injection molding machines and assembling robots, the time-series data may be acquired in that unit, whereas in the case of a target that has no clear start point or end point such as motors and engines, acceleration data or the like within a certain period may be acquired. The time-series data to be acquired may be data such as acceleration, velocity, and position, or data representing a vibration phenomenon (such as amplitude, frequency, attenuation rate, and resonance). In the case where the target operates with electricity, it may be electrical data representing changes along the time axis, such as applied voltage and current. In the case of engines or turbines, time-series data such as pressure and temperature may be used. The first- or second-order derivative of data, for example, may also be used. The time-series data may be a single data, or it may be multi-dimensional data such as triaxial acceleration data. The time-series data may also be treated as multidimensional time-series data combining the various types of data described above.

The operation conditions of the inspection target are “normal operation” or “normal operation” without any abnormalities in the operation conditions assumed in advance regarding the state of the inspection target, or “abnormal operation” deviating from such operation. Naturally, the operation state need not be divided into two categories, such as normal (usual) and abnormal, but may include three categories of abnormal operation, such as normal (usual), caution required, and abnormal. The operation of the inspection target includes the movement of the inspection target itself, such as the rotation of a motor or the molding operation of an injection molding machine. The time-series data reflecting the operation of the inspection target should reflect such operation of the inspection target, and the inspection target from which the time-series data referenced when obtaining the center-of-gravity vector is obtained and the inspection target from which the detection time-series data obtained when obtaining the detecting state vector are obtained may be the same or different. The inspection target from which the time-series data is obtained may be the same or different. The center-of-gravity vector may be obtained by means of the time-series data obtained from the same type of apparatus, and the detection time-series data from a different inspection target may be used when generating scores. For example, if the inspection target is a motor or other mass-produced item, a plurality of samples may be used when obtaining the center-of-gravity vector, and the specific motor actually used may be used as the inspection target when obtaining the score. Naturally, for a product that is large and continuously used, such as an injection molding machine, the center-of-gravity vector may be obtained by obtaining time-series data for a specific product, and the detecting state vector may be obtained from the detection time-series data obtained for the same product.

The center-of-gravity vector storage unit storing center-of-gravity vectors of respective N (1≤N) clusters obtained by dividing into clusters a plurality of state vectors obtained from time-series data reflecting an operation of the inspection target may be prepared prior to the generation of scores by the detection apparatus, or if the generated score is determined to be normal when the score generated by the detection apparatus, the center-of-gravity vector of the cluster may be updated using the detecting state vector that is used for the generation of the score. Since the score is generated as the distance of the detecting state vector from the center-of-gravity vector of the cluster, it may be treated as a scalar quantity as the distance from a single center-of-gravity vector, or as a vector of two or more dimensions as the distance from a plurality of center-of-gravity vectors.

(2) In the above-described configuration, the score generation unit may include an identification unit configured to identify as a failure score of the inspection target a smallest distance among distances of the detecting state vector from the N center-of-gravity vectors. In this manner, when the inspection target is not normal, the failure score reflecting that state can be easily determined. When the above-mentioned score and failure score are generated or identified, the state of the inspection target can be traced. In the case where the inspection target is placed on the market and experiences a failure or other abnormality within or after the guaranteed period of operation, when a score or failure score is obtained, this can be traced to verify the relationship between the initial situation and subsequent changes in the inspection target and the like, for example. Even if the inspection target has no failure or other abnormality, the relationship between the score or failure score and the subsequent normality of the inspection target can be verified.

(3) The above-described configuration (1) or (2) may further include an output unit configured to output an index corresponding to a possibility of a failure of the inspection target when the failure score is equal to or greater than a predetermined value. In this manner, the possibility that the inspection target is in a condition that could lead to failure can be known and responded to, for example, by correcting, repairing, reassembling, or sorting the object before shipment.

(4) In the above-described configurations (1) to (3), the detection apparatus may include the center-of-gravity vector storage unit and the score generation unit in a proximity apparatus, the proximity apparatus being provided in close proximity to the inspection target and configured to directly input the time-series data reflecting the operation of the inspection target. In this manner, the center-of-gravity vector can be immediately referenced and scores can be easily generated. In the above-described first embodiment, the detection apparatus 10 is provided in close proximity to the rotor apparatus 30, and configured as a proximity apparatus that directly inputs time-series data. In some cases, clustering and calculation of the center-of-gravity vector may be performed on the basis of the state vector determined by inputting the detection time-series data so as to update the storage contents of the center-of-gravity vector storage unit with the calculated new center-of-gravity vector.

(5) In the above-described configurations (1) to (3), the detection apparatus may include the score generation unit in a proximity apparatus provided in close proximity to the inspection target and configured to directly input the detection time-series data, and the center-of-gravity vector storage unit in a cloud coupled with the proximity apparatus through a network and configured to exchange data with the proximity apparatus. In this manner, high-load processes such as generation of the center-of-gravity vector can be performed on the cloud side, and the internal configuration of the proximity apparatus can be simplified.

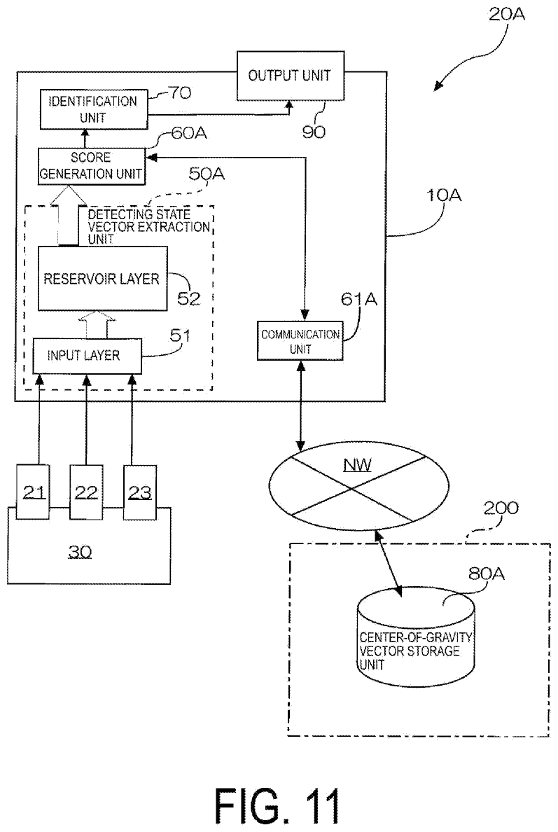

FIG. 11 illustrates an example of such a configuration of an abnormality detection system 20A. A detection apparatus 10A serving as the proximity apparatus is coupled to a server 200 placed in the cloud through a network NW such as the Internet, and can access a center-of-gravity vector storage unit 80A in a storage medium 210 such as a hard disk in the server 200. The detection apparatus 10A outputs the detecting state vector with a detecting state vector extraction unit 50A with the input of the signal from the triaxial acceleration sensors 21 to 23 of the rotor apparatus 30. When receiving the detecting state vector, a score generation unit 60A refers to the center-of-gravity vector storage unit 80A of the server 200 through the network NW from a communication unit 61A, and generates the score in accordance with the distance from the center-of-gravity vector stored there. Other configurations are the same as those of the first embodiment.

(6) In the above-described configurations (1) to (3), the detection apparatus may include a proximity apparatus provided in close proximity to the inspection target and configured to directly input the detection time-series data, and the center-of-gravity vector storage unit and the score generation unit in a cloud coupled with the proximity apparatus through a network and configured to exchange data with the proximity apparatus. In this manner, high-load processes such as generation of the center-of-gravity vector and generation of the score can be performed on the cloud side, and the configuration in the proximity apparatus can be simplified.

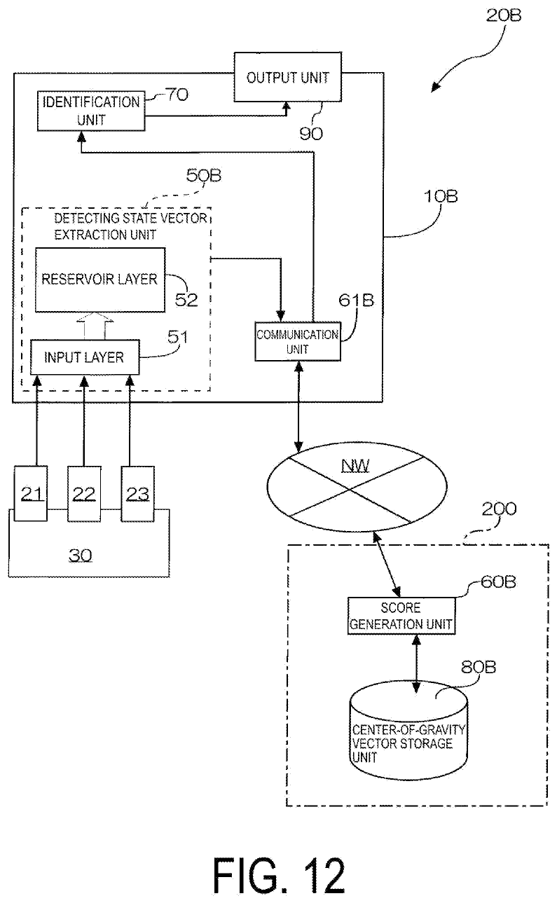

FIG. 12 illustrates an example of a configuration of such an abnormality detection system 20B. A detection apparatus 10B serving as the proximity apparatus is coupled to the server 200 placed in the cloud through a network NW such as the Internet, and can output the detecting state vector extracted by a detecting state vector extraction unit 50B to a score generation unit 60B provided in the server 200 through a communication unit 61B and the network NW. The score generation unit 60B in a server 200B refers to a center-of-gravity vector storage unit 80B in the storage medium 210 such as a hard disk, and generates the score in accordance with the distance from the center-of-gravity vector stored there. The generated score is sent back to the detection apparatus 10B through the network NW and the communication unit 61B. Other configurations are the same as those of the first embodiment.

(7) The present disclosure can be implemented as a detection method of detecting an operation state of an inspection target. The method includes storing center-of-gravity vectors of respective N clusters obtained by dividing into clusters a plurality of state vectors obtained from time-series data reflecting an operation of the inspection target, N satisfying 1≤N, and extracting a detecting state vector from detection time-series data after the center-of-gravity vector is stored and generating a score of the operation state of the inspection target in accordance with a distance of the detecting state vector from the center-of-gravity vector, the detection time-series data being the time-series data obtained anew for the inspection target. With this detection method, by extracting the detecting state vector from the detection time-series data obtained anew for the inspection target, it is possible to generate the score of the operation state of the inspection target generated in accordance with the distance of the detecting state vector from the center-of-gravity vector. The inspection target and the like are the same as those of the inspection apparatus of the above-described (1).

(8) The present disclosure can be implemented as an apparatus for providing a center-of-gravity vector for detection. The apparatus for providing a center-of-gravity vector for detection includes an accumulation unit configured to accumulate, as a state vector, time-series data reflecting an operation of an inspection target, a dividing unit configured to divide into clusters a plurality of N state vectors accumulated, the N satisfying 1≤N, a center-of-gravity vector storage unit configured to store the center-of-gravity vector determined for each of the clusters divided, and a provision unit configured to provide, for comparison to detect an operation state of the inspection target, the center-of-gravity vector stored, in response to a request from outside. In this manner, the center-of-gravity vectors determined for N clusters obtained by dividing the plurality of state vectors reflecting the operation of the inspection target can be easily provided to the external apparatus that detects the operation state of the inspection target.

(9) In the above-described configuration, the accumulation unit may include a multi-layer, recurrent neuron network configured for input of the time-series data, and accumulates an output of the neuron network as the state vector. In this manner, the time-series data can be easily processed, and the state vectors can be accumulated in a simple manner.

(10) In the above-described configuration, the accumulation unit may operate the neuron network by an algorithm of echo state network or liquid state machine.

(11) In each of the above embodiments, some of the configurations that are implemented by hardware may be implemented by software. At least some of the configurations that are implemented by software may be implemented by discrete circuit configurations. When some or all of the functions of the present disclosure are implemented by software, the software (computer program) can be provided in a form stored in a computer-readable recording medium. The term “computer-readable recording medium” is not limited to portable recording media such as flexible disks and CD-ROMs, but also includes internal storage devices in the computer such as various types of RAM and ROM, and external storage apparatuses fixed in the computer such as hard disks. It includes. In other words, “computer-readable recording medium” has a broad meaning that includes any recording medium in which data packets can be fixed rather than temporary.

The disclosure is not limited to the exemplary embodiments described above, and can be realized in various configurations without departing from the gist of the disclosure. For example, appropriate replacements or combinations may be made to the technical features in the exemplary embodiments which correspond to the technical features in the aspects described in the SUMMARY section to solve some or all of the problems described above or to achieve some or all of the advantageous effects described above. Furthermore, when the technical characteristics are not described as being essential in the present specification, the technical characteristics can be deleted as appropriate.

What is claimed is:

1. A detection apparatus configured to detect an operation state of an inspection target, the detection apparatus comprising:
a center-of-gravity vector storage unit storing center-of-gravity vectors of respective N clusters obtained by dividing into clusters a plurality of state vectors obtained from time-series data reflecting an operation of the inspection target, N satisfying 1≤N; and
a score generation unit configured to extract a detecting state vector from detection time-series data after the center-of-gravity vector is stored and generate a score of the operation state of the inspection target in accordance with a distance of the detecting state vector from the center-of-gravity vector, the detection time-series data being the time-series data obtained anew for the inspection target.

2. The detection apparatus according to claim 1, wherein the score generation unit includes an identification unit configured to identify as a failure score of the inspection target a smallest distance among distances of the detecting state vector from the N center-of-gravity vectors.

3. The detection apparatus according to claim 2, further comprising an output unit configured to output an index corresponding to a possibility of a failure of the inspection target when the failure score is equal to or greater than a predetermined value.

4. The detection apparatus according to claim 1, wherein the detection apparatus includes the center-of-gravity vector storage unit and the score generation unit in a proximity apparatus, the proximity apparatus being provided in close proximity to the inspection target and configured to directly input the time-series data reflecting the operation of the inspection target.

5. The detection apparatus according to claim 1, wherein the detection apparatus includes
the score generation unit in a proximity apparatus provided in close proximity to the inspection target and configured to directly input the detection time-series data, and
the center-of-gravity vector storage unit in a cloud coupled with the proximity apparatus through a network and configured to exchange data with the proximity apparatus.

6. The detection apparatus according to claim 1, wherein the detection apparatus includes
a proximity apparatus provided in close proximity to the inspection target and configured to directly input the detection time-series data, and
the center-of-gravity vector storage unit and the score generation unit in a cloud coupled with the proximity apparatus through a network and configured to exchange data with the proximity apparatus.

7. A detection method of detecting an operation state of an inspection target, the method comprising:
storing center-of-gravity vectors of respective N clusters obtained by dividing into clusters a plurality of state vectors obtained from time-series data reflecting an operation of the inspection target, N satisfying 1≤N; and
extracting a detecting state vector from detection time-series data after the center-of-gravity vector is stored and generating a score of the operation state of the inspection target in accordance with a distance of the detecting state vector from the center-of-gravity vector, the detection time-series data being the time-series data obtained anew for the inspection target.

8. An apparatus for providing a center-of-gravity vector for detection, comprising:
an accumulation unit configured to accumulate, as a state vector, time-series data reflecting an operation of an inspection target;
a dividing unit configured to divide into clusters a plurality of N state vectors accumulated, the N satisfying 1≤N;
a center-of-gravity vector storage unit configured to store the center-of-gravity vector determined for each of the clusters divided; and
a provision unit configured to provide, for comparison to detect an operation state of the inspection target, the center-of-gravity vector stored, in response to a request from outside.

9. The apparatus for providing the center-of-gravity vector for detection according to claim 8, wherein the accumulation unit includes a multi-layer, recurrent neuron network configured for input of the time-series data, and accumulates an output of the neuron network as the state vector.

10. The apparatus for providing the center-of-gravity vector for detection according to claim 9, wherein the accumulation unit operates the neuron network by an algorithm of echo state network or liquid state machine.
